(19) United States
(12) Patent Application Publication
(10) Pub. No.: US 2019/0087782 A1
(43) Pub. Date: Mar. 21, 2019

(54) COGNITIVE, DYNAMIC ASSESSMENT ADVISOR OR BUILDER

(71) Applicant: International Business Machines Corporation, Armonk, NY (US)

(72) Inventors: Gautam Lolla, Andhra Pradesh (IN); Trinadh Raja, Andhra Pradesh (IN); Srikanth Vankara, Andhra Pradesh (IN)

(21) Appl. No.: 15/708,410

(22) Filed: Sep. 19, 2017

(51) Int. Cl. G06Q 10/10; G06F 17/30; G06Q 10/06

(52) U.S. Cl. CPC G06Q 10/1053; G06Q 10/06398; G06F 17/30979

(57) ABSTRACT

A system and method of implementing a cognitive, dynamic assessment advisor or builder receives a requirement indicating a job or task. The method includes obtaining records from a database that relate to the requirement, and filtering assessment elements or assessments among the records to develop a listing of assessment elements or a set of assessments. The assessment elements are questions or tests to determine suitability for the job or task and each of the assessments include a set of the assessment elements. The listing of assessment elements or the set of assessments is provided for administering to candidates for the job or task.

### BACKGROUND

The present invention relates to assessment technology, and more specifically, to a cognitive, dynamic assessment advisor or builder.

Assessment technology refers to the generation of an assessment comprising questions or tests to evaluate candidates for a job or role based on specified requirements. The responsibility for the assessment of and selection among candidates, at least at the initial stages prior to an interview, has increasingly shifted to human resources (HR) or personnel departments that may lack knowledge about the skill set needed for particular positions. As a result, the generation of assessments that properly filter candidates based on skills, qualifications, experience, and competencies is increasingly important in finding candidates. The manual generation of an effective assessment for each job or role would either require input from the individual or organization seeking the candidate, thereby undercutting the time savings of outsourcing the hiring process, or expertise about the actual job or role that is beyond the knowledge of the HR or personnel department. Accordingly, assessment technology has emerged to aid in the generation of assessments. While previous systems generate an assessment based on a requirement, increased flexibility in the form of a cognitive, dynamic assessment advisor or builder would improve assessment technology.

### SUMMARY

Embodiments of the present invention are directed to a computer-implemented method of implementing a cognitive, dynamic assessment advisor or builder includes receiving a requirement, the requirement indicating a job or task. The method also includes obtaining records from a database that relate to the requirement, and filtering assessment elements or assessments among the records to develop a listing of assessment elements or a set of assessment. The assessment elements are questions or tests to determine suitability for the job or task and each of the assessments include a set of the assessment elements. The listing of assessment elements or the set of assessments is provided for administering to candidates for the job or task.

Additional embodiments of the present invention are directed to a system to implement a cognitive, dynamic assessment advisor or builder. The system includes a database storing records that relate to a requirement. The requirement indicates a job or task. The system also includes a processor to receive the requirement, filter assessment elements or assessments among the records to develop a listing of assessment elements or a set of assessments. The assessment elements are questions or tests to determine suitability for the job or task and each of the assessments include a set of the assessment elements, and provide the listing of assessment elements or the set of assessments for administering to candidates for the job or task.

Further embodiments of the present invention are directed to a computer program product for implementing a cognitive, dynamic assessment advisor or builder. The computer program product includes a computer readable storage medium having program instructions embodied therewith, and the program instructions are executable by a processor to perform a method including receiving a requirement, the requirement indicating a job or task. The method also includes obtaining records from a database that relate to the requirement, and filtering assessment elements or assessments among the records to develop a listing of assessment elements or a set of assessments. The assessment elements are questions or tests to determine suitability for the job or task and each of the assessments include a set of the assessment elements. The listing of assessment elements or the set of assessments is provided for administering to candidates for the job or task.

### BRIEF DESCRIPTION OF THE DRAWINGS

FIG. 1 is a block diagram of a system to perform as a cognitive, dynamic assessment advisor or builder according to one or more embodiments;

FIG. 2 is a process flow of a method of implementing a cognitive, dynamic assessment advisor according to one or more embodiments; and

FIG. 3 is a process flow of a method of implementing a cognitive, dynamic assessment advisor or builder according to additional or alternate embodiments.

### DETAILED DESCRIPTION

As previously noted, an assessment refers to a set of questions or tests that relate to the requirements of a particular job or role. An assessment helps to ensure that a qualified candidate is selected for a job or task even when the decision maker is not knowledgeable regarding the skills needed for the job. Prior assessment systems and methods include those that compile user selections or provide a user interface to facilitate assessment construction, for example.

Embodiments of the systems and methods detailed herein relate to a cognitive, dynamic assessment advisor or builder. Specifically, a set of assessments are presented for selection or a set of questions or tests (referred to as assessment elements) are provided to facilitate the development of an assessment. The set of assessments may be presented according to different embodiments. According to one embodiment, historical data related to assessments used for the same requirement is used to develop the assessments. According to other embodiments, a database of assessment elements is used to develop the assessments or to present the assessment elements for the development of an assessment. The embodiments detailed herein improve upon existing assessment technology by providing an assessment advisor with characterizations corresponding with assessments to facilitate selection or an assessment builder with characterizations corresponding with assessment elements to facilitate generation of an assessment.

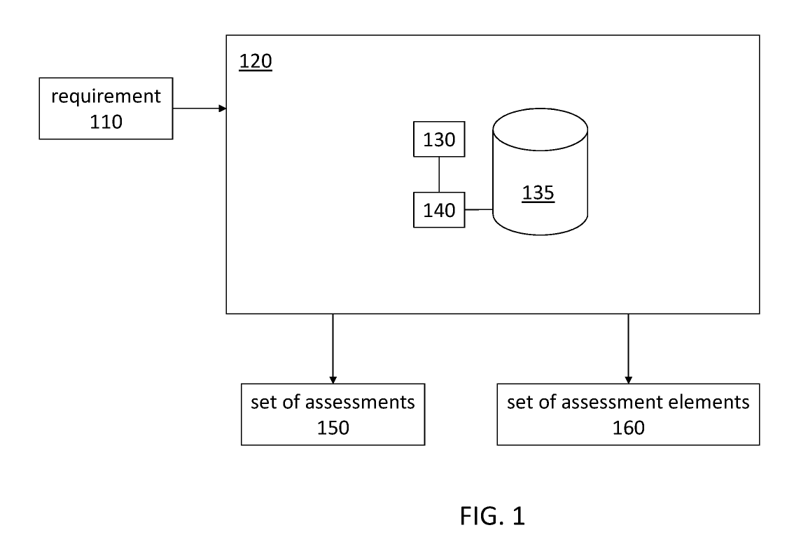

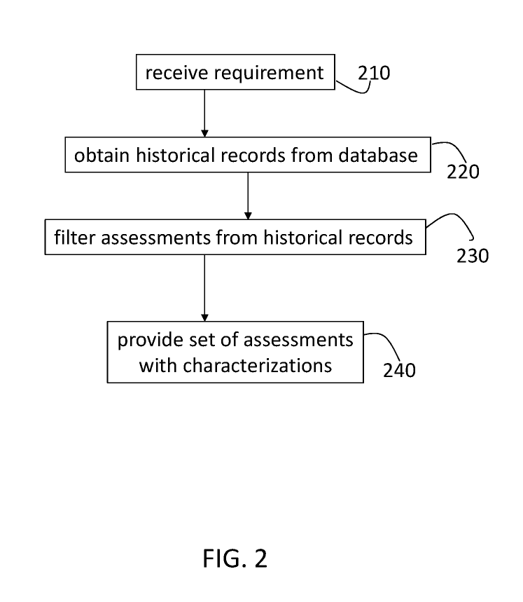

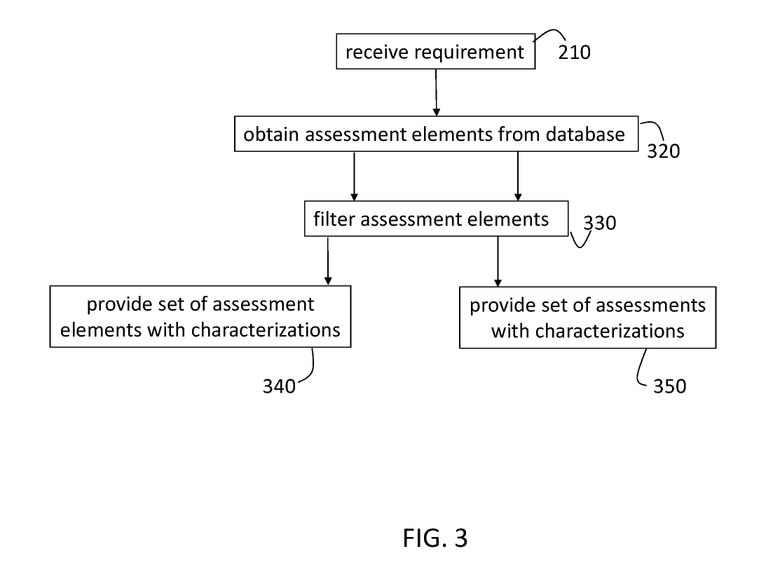

FIG. 1 is a block diagram of a system 120 to perform as a cognitive, dynamic assessment advisor or builder according to one or more embodiments. The system 120 includes one or more memory devices 130 and one or more processors 140. The system 120 also includes a database 135 that may be part of the memory device 130 or may be stored separately. The memory device 130 or a combination of the memory device 130 and database 135 store instructions, including instructions to implement algorithms according to one or more embodiments, processed by the processor 140 that are detailed with reference to FIGS. 2 and 3. The memory device 130 and the database 135 are computer readable storage media. As further detailed with reference to FIGS. 2 and 3, the database 135 may store historical data, assessment elements, or both.

The system 120 also includes known components to receive inputs and provide outputs. For example, the system 120 may be implemented as a computer with a keyboard input and a display device as an output that implements the algorithms discussed with reference to FIGS. 2 and 3 to perform the special purpose of acting as an assessment advisor or builder. The system 120 may alternatively or additionally include an interface to provide communication wirelessly, for example, to provide outputs to a different system. The system 120 can receive an input of a requirement generated at block 110. The requirement identifies the job or task or, put another way, indicates a prerequisite for candidates applying for a job or task. For example, the requirement may specify a programmer of a specific computer language with 3 years of experience. According to embodiments that are further detailed with reference to FIGS. 2 and 3, the system 120 can provide assessments for selection at block 150 or a set of assessment elements at block 160. The assessments, each of which is made up of assessment elements, can be regarded as the criteria used to judge the suitability of the candidates for the job or task identified by the requirement. The outputs provided at block 150 and 160 include characterizations of the assessments or assessment elements that facilitate selection.

FIG. 2 is a process flow of a method of implementing a cognitive, dynamic assessment advisor according to one or more embodiments. At block 210, receiving the requirement generated at block 110 includes the system 120 receiving an input that can include selections additional to the requirement. These selections are further discussed. The input can be in the form of a keyboard input by an operator, for example. At block 220, obtaining historical records from the database 135 includes the processor 140 accessing records associated with the same requirement that was received at block 210. For example, if the requirement is a computer programmer of a particular language with 3 years of experience, then previously administered assessments for the same requirement and a historical record of the assessment results are obtained from the database 135.

Filtering assessments from the historical records, at block 230, can be based on several factors. The filter involves the processor 140 sorting previously used assessments in the historical records according to one or more factors. The factors can include an indication of the difficulty of the previously used assessments. This indication can be based on the percentage of takers of each of the previously used assessments who passed, for example. The factors can also include an indication of the success of each of the previously used assessments in yielding a successful candidate. This indication can be based on an employer-provided rating of hired candidates corresponding with each of the previously used assessments, for example. These factors represent an exemplary rather than an exhaustive set of factors that can be used to sort the previously used assessments. Factors can be selected or limited according to the selections received at block 210. For example, the selection may indicate that previously used assessments should only be sorted based on associated ratings of hired candidates.

At block 240, providing the set of assessments with characterizations refers to providing the set of assessments for selection at block 150. The characterizations relate to the factors used in the filtering (at block 230). For example, if the processor 140 sorts the previously used assessments based on the percentage of takers who passed, then the previously used assessments may be provided for selection at block 150 with a characterization relating to difficulty. That is, the previously used assessments can be provided in a set from most difficult (i.e., associated with the lowest percentage of assessment takers passing) to easiest (i.e., associated with the highest percentage of assessment takers passing). The characterization can be regarded as a qualitative indication of the factors. For example, when the factor used in the filtering, at block 230, indicates that less than 20 percent of the takers of an assessment passed, the associated characterization can be a difficult assessment. The mapping between the factors and characterizations can be predefined or dynamically selected.

As another example of characterization, if the processor 140 sorts the previously used assessments based on the success of the candidates hired with the use of the assessment, then the characterization can relate to success. That is the previously used assessments can be provided in a set from most successful (i.e., characterized as such when the candidate has a rating above an upper threshold value) to least successful (i.e., characterized as such when the candidate has a rating below a lower threshold value). Assessments that yielded candidates with ratings below the upper threshold value but above the lower threshold value may be characterized as intermediate assessments. When the input includes a selection that limits the filtering, at block 230, the number of sets of assessments (i.e., the number of ways that previously used assessments are sorted) is correspondingly limited. At block 150, the characterization can be used to select one of the previously used assessments to be administered. Thus, according to the embodiment shown in FIG. 2, the system 120 acts as a cognitive, dynamic assessment advisor.

FIG. 3 is a process flow of a method of implementing a cognitive, dynamic assessment advisor or builder according to additional or alternate embodiments. At block 210, the processes include receiving the requirement generated at block 110, as discussed with reference to FIG. 2. As also discussed with reference to FIG. 2, the input can include additional selections, which are detailed below. At block 320, obtaining assessment elements from the database 135 includes the processor 140 accessing existing assessment elements corresponding with the same requirement that was received at block 210. As further discussed with reference to the processing at block 330, the assessment elements are stored in correspondence with one or more characterizations. These assessment elements and their characterizations can be generated and stored by hiring managers, project groups that generate the requirement at block 110, or any number of sources. The assessment elements can be part of previously used assessments, as well, but are not stored in correspondence with historical records that indicate outcomes for those previously used assessments.

At block 330, filtering the assessment elements can be based on characterizations in a similar way that filtering assessments at block 230 can be based on different factors. Also similarly to the filtering at block 230, the filtering at block 330 can be affected by selections provided with the requirement. Because historical records are not associated with the assessment elements, the filtering relies on characterizations that are stored in association with the assessment elements. For example, each assessment element may be stored with one or more corresponding characterizations that indicate that the assessment element is rated as difficult, moderate, or easy. Another exemplary characterization may indicate the importance of the assessment element as primary or secondary.

Providing the set of assessment elements with their corresponding characterizations at block 340 includes providing a set for each type of filtering, at block 330, for use at block 160. For example, if a user selection or the available characterizations led to each assessment element corresponding with a single characterization (e.g., one indicating the level of difficulty), then one set of assessment elements sorted by their level of difficulty would be provided at block 340. If each assessment element corresponds to multiple characterizations and a selection does not limit the filtering to only one characterization, then more than one sorting of assessment elements is provided at block 340. For example, assessment elements can be sorted by level of difficulty and also sorted by primary or secondary importance. According to the embodiment associated with the output at block 340, the system 120 acts as a cognitive, dynamic assessment advisor.

At block 350, providing the set of assessments with characterizations includes generating assessments from the filtered assessment elements for selection at block 150. One of the selections provided at block 210 can be the number of assessment elements per assessment, for example. Assessments of different types can be provided, at block 350, that each include the specified number of assessment elements. The selection can also limit the number and type of assessments. For example, if each assessment element corresponds to multiple characterizations, only one assessment with the specified number of assessment elements that are all characterized as difficult or of primary importance can be selected. When no selection is provided with the requirement, a set of assessments of different types can be provided at block 350. The set of assessments can include an assessment with a random mix of assessment elements with different characterizations, another assessment with only assessment elements with a corresponding characterization as difficult, another assessment with only assessment elements with a corresponding characterization as easy, another assessment with only assessment elements with a corresponding characterization as primary importance, and so on. In this way, a selection can be made among the set of assessments at block 150 so that the selected assessment can be administered. According to the embodiment associated with the output at block 350, the system 120 acts as a cognitive, dynamic assessment builder.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1-7. (canceled)

8. A system to implement a cognitive, dynamic assessment advisor or builder, the system comprising:
a database storing records that relate to a requirement, wherein the requirement indicates a job or task; and
a processor configured to receive the requirement, filter assessment elements or assessments among the records to develop a listing of assessment elements or a set of assessments, wherein the assessment elements are questions or tests to determine suitability for the job or task and each of the assessments include a set of the assessment elements, and provide the listing of assessment elements or the set of assessments for administering to candidates for the job or task.

9. The system according to claim 8, wherein the records include historical records for the requirement that include previously used assessments for the requirement.

10. The system according to claim 9, wherein the processor filters the assessments by sorting the previously used assessments based on a percentage of takers who passed for each of the previously used assessments.

11. The system according to claim 9, wherein the processor filters the assessments by sorting the previously used assessments based on employer-provided ratings of hired candidates corresponding with each of the previously used assessments.

12. The system according to claim 8, wherein the records include generated assessment elements corresponding with the requirement.

13. The system according to claim 12, wherein the processor filters the assessment elements by sorting the generated assessment elements based on characterizations.

14. The system according to claim 13, wherein the processor sorting the generated assessment elements based on characterizations includes sorting the generated assessment elements based on difficulty.

15. A computer program product for implementing a cognitive, dynamic assessment advisor or builder, the computer program product comprising a computer readable storage medium having program instructions embodied therewith, the program instructions executable by a processor to perform a method comprising:
receiving a requirement, the requirement indicating a job or task;
obtaining records from a database that relate to the requirement;
filtering assessment elements or assessments among the records to develop a listing of assessment elements or a set of assessments, wherein the assessment elements are questions or tests to determine suitability for the job or task and each of the assessments include a set of the assessment elements; and
providing the listing of assessment elements or the set of assessments for administering to candidates for the job or task.

16. The computer program product according to claim 15, wherein the obtaining the records includes obtaining historical records for the requirement that include previously used assessments for the requirement.

17. The computer program product according to claim 16, wherein the filtering the assessments includes sorting the previously used assessments based on a percentage of takers who passed for each of the previously used assessments or based on employer-provided ratings of hired candidates corresponding with each of the previously used assessments.

18. The computer program product d according to claim 15, wherein the obtaining the records includes obtaining generated assessment elements corresponding with the requirement.

19. The computer program product according to claim 18, wherein the filtering the assessment elements includes sorting the generated assessment elements based on characterizations.

20. The computer program product according to claim 19, wherein the sorting the generated assessment elements based on characterizations includes sorting the generated assessment elements based on difficulty.
